(19) United States
(12) Patent Application Publication
(10) Pub. No.: US 2009/0202677 A1
(43) Pub. Date: Aug. 13, 2009

(54) METHOD FOR MANUFACTURING HEALTH FOOD CONTAINING ENZYME, AND HEALTH FOOD

(75) Inventor: Takashi KONDO, Myoko-shi (JP)

Correspondence Address: SUGHRUE MION, PLLC, 2100 PENNSYLVANIA AVENUE, N.W., SUITE 800, WASHINGTON, DC, 20037, US

(73) Assignee: MIYATOU YASOU KENKYUJO CO., LTD., Myoko-shi (JP)

(21) Appl. No.: 12/361,917

(22) Filed: Jan. 29, 2009

(30) Foreign Application Priority Data
Jan. 30, 2008 (JP) 2008-019477

(51) Int. Cl. A23L 1/28

(52) U.S. Cl. 426/52; 426/648

(57) ABSTRACT

According to the present invention there is provided a method for manufacturing a health food containing enzymes. Ingesting the health food yields a variety of exceptional effects derived from the enzymes, coenzymes, minerals, vitamins, amino acids and other organic acids, and other active ingredients contained in an herb, a vegetable, a fruit, kelp, and fermented calcium. The invention is a method for manufacturing a health food containing enzymes, wherein a first fermentation liquor is obtained by adding a sugar, an herb, a vegetable fermentation liquor, a fruit fermentation liquor, a kelp fermentation liquor, fermented calcium, and brown sugar bacteria to an herb extract; and carrying out fermentation; a second fermentation liquor is subsequently obtained by adding a papaya fermentation liquor to the first fermentation liquor, and carrying out fermentation and ripening; and the second fermentation liquor is subsequently filtered.

### BACKGROUND OF THE INVENTION

1. Field of the Invention

The present invention relates to a method for manufacturing a health food containing enzymes, and a health food.

Over the past several years, contemporary lifestyles have increasingly required people to aid their digestive functions. This is partially due to the fact that people who lead such lifestyles consume large amounts of processed food and fats without sufficient quantities of vegetables, and are also subjected to a variety of forms of stress.

2. Description of the Related Art

A variety of digestive enzymes (e.g., proteolytic, glycolytic, and lipolytic enzymes) are secreted in the body when ingested foods are then digested and absorbed in the digestive tract. However, metabolic competence declines with age; therefore, the ability to synthesize these digestive enzymes correspondingly declines, ingested foods become harder to digest and absorb, and the nutritional components present in the foods are not effectively used to advantage. As a result, the incidence of illnesses and other adverse conditions is higher. Accordingly, it appears that in order to lead a modern lifestyle, people wish to ingest foods that contain active ingredients for aiding digestion, particularly as they age.

Accordingly, as disclosed in, e.g., JP-B 3370302, the inventor proposed a method for manufacturing a health food in which papaya is employed as a health food containing enzymes that exhibits the effects enumerated above (“prior art example” hereunder).

The prior art example is a health food containing nutritious microorganisms, enzymes, and other ingredients; and is obtained by extracting a nutritious essence contained in the papaya, and subsequently using normal yeasts, natural yeasts adhering to the papaya, and lactobacilli to carry out fermentation and ripening. This allows a variety of enzymes, beneficial bacteria, and other ingredients to be readily ingested.

As a result of further research and development on the prior art example, the inventor was able to provide a method for manufacturing a health food containing enzymes, and a health food, wherein a diversity of herbs, vegetables, and fruits were caused to ferment, whereby a wide range of enzymes, coenzymes, vitamins, amino acids, organic acids, minerals, and a variety of other active ingredients present in the herbs, vegetables, and fruit were converted into a state allowing absorption by the body, and into a readily ingestible liquid, and wherein ingesting the food allows one to experience a very high level of the effects derived from the enzymes, coenzymes, vitamins, amino acids, organic acids, minerals, and other active ingredients present in the herbs, vegetables, and fruit; such effects being impossible to experience merely by eating large quantities of the herbs, vegetables, and fruits in their raw form.

### SUMMARY OF THE INVENTION

A description of the main points of the present invention shall now be provided with reference to the accompanying drawing.

An invention according to a first aspect is a method for manufacturing a health food containing enzymes, wherein: a first fermentation liquor is obtained by decocting an herb to yield an extract; adding a sugar, an herb, a vegetable fermentation liquor, a fruit fermentation liquor, a kelp fermentation liquor, fermented calcium, and brown sugar bacteria to the herb extract at a temperature where enzyme activity can be maintained; and carrying out fermentation; a second fermentation liquor is subsequently obtained by adding a papaya fermentation liquor to the first fermentation liquor, and carrying out fermentation and ripening; and the second fermentation liquor is subsequently filtered.

An invention according to a second aspect is the method according to the first aspect, wherein: the herb extract has Artemisia varindica Pampan admixed therewith; the vegetable fermentation liquor is obtained by adding a sugar to a vegetable, adding a yeast to an extracted essence, and carrying out fermentation; the fruit fermentation liquor is obtained by adding a sugar to a fruit, adding a yeast to an extracted essence, and carrying out fermentation; the kelp fermentation liquor is obtained by adding a sugar to kelp, adding a yeast to an extracted essence, and carrying out fermentation; the fermented calcium is obtained by blending an essence with a fossilized shell, an oyster shell, a fish bone, a pork bone, or the like; and carrying out fermentation, drying, and subsequent pulverization, the essence being obtained by adding a sugar to a vegetable, a fruit, a sea grass, a cereal, a plant leaf, or the like; and carrying out fermentation; and the papaya fermentation liquor is obtained by adding a sugar to a papaya, adding a yeast and a lactobacillus to an extracted essence, and carrying out fermentation.

An invention according to a third aspect is the method according to the second aspect, wherein the papaya fermentation liquor has charcoal added thereto.

An invention according to a fourth aspect is the method according to the third aspect, wherein the charcoal is a carbonized herb.

An invention according to a fifth aspect is the method according to the first aspect, wherein the first fermentation liquor includes an aloe fermentation liquor.

An invention according to a sixth aspect is a health food manufactured using the method of the first aspect, wherein the sugar degree of the health food is 45° or higher.

An invention according to a seventh aspect is a health food manufactured using the method of the second aspect, wherein the sugar degree of the health food is 45° or higher.

An invention according to an eighth aspect is a health food manufactured using the method of the third aspect, wherein the sugar degree of the health food is 45° or higher.

An invention according to a ninth aspect is a health food manufactured using the method of the fourth aspect, wherein the sugar degree of the health food is 45° or higher.

An invention according to a tenth aspect is a health food manufactured using the method of the fifth aspect, wherein the sugar degree of the health food is 45° or higher.

As described above, the present invention assumes the form of a liquid in a state that allows the body to readily absorb enzymes, coenzymes, minerals, vitamins, amino acids and other organic acids, and other active ingredients contained in an herb, a vegetable, a fruit, kelp, and fermented calcium. Therefore, a variety of exceptional effects derived from these active ingredients will be obtained; i.e., digestion of food, absorption of nutrients, and other functions will be promoted. For example, the immune system will be boosted, constitution will improve, and illness will be preventable.

### BRIEF DESCRIPTION OF THE DRAWINGS

Several preferred embodiments of the present invention will be described in detail hereinafter with reference to the accompanying drawing, wherein:

FIG. 1 is a diagram showing steps for manufacturing the present embodiment.

### DESCRIPTION OF THE PREFERRED EMBODIMENTS

First, Polygonatum falcatum A. Gray, Gynostemma pentaphyllum and other herbs (called “yasou” [symbol] in Japan; and hereinafter simply referred to as “herb”) are decocted in boiling water, the mineral content is extracted from the herb, and a herb extract is obtained. The temperature of the extract is then lowered, and the extract is converted to a state wherein the enzymes can retain their activity in the subsequent steps. To the herb extract are added a sugar, an herb, a vegetable fermentation liquor, a fruit fermentation liquor, a kelp fermentation liquor, fermented calcium, and brown sugar bacteria (called “kokutokin” [symbol] in Japan; and hereinafter simply referred to as “brown sugar bacteria”). Fermentation is carried out, and a first fermentation liquor that contains a variety of active ingredients is obtained.

The sugar may be superfine sugar, brown sugar, an oligosaccharide, or the like. The sugar increases the sugar degree of the first fermentation liquor, and is a source of nutrients for brown sugar bacteria or other zymogens.

The herb is Gynostemma pentaphyllum (Thunb.) Makino, Hypericum erectum Thunb. ex Murray var. erectum, or the like. The natural yeast originally present on the herb promotes fermentation, and the mineral content of the herb will also be extracted.

The vegetable fermentation liquor is obtained by adding sugar to bean sprouts, a cucumber, or another vegetable in a raw state; admixing the sugar therewith; changing the osmotic pressure; adding yeast or brown sugar bacteria to an essence in the vegetable cells that has been extracted from the cells; carrying out fermentation; and separating off the liquid content using a press. Specifically, the raw vegetables are caused to ferment into a liquid state, and the residue is removed, leaving a vegetable fermentation liquor containing large quantities of only the active ingredients.

The fruit fermentation liquor is obtained by adding sugar to a pineapple, an apple, or another fruit in a raw state; admixing the sugar therewith; changing the osmotic pressure; adding yeast or brown sugar bacteria to an essence in the fruit cells that has been extracted from the cells; carrying out fermentation; and separating off the liquid content using a press. Specifically, the raw fruit is caused to ferment into a liquid state, and the residue is removed, leaving a fruit fermentation liquor containing large quantities of only the active ingredients.

The resulting vegetable and fruit fermentation liquors are obtained through fermentation without using heat; therefore, even small quantities of the liquor will contain particularly large quantities of the enzymes, coenzymes, and other ingredients. Specifically, the enzymes, coenzymes, and other ingredients contained in the fruits and vegetables would be destroyed by heating; therefore, in the present invention, a method is adopted wherein the ingredients are extracted in the form of a fermentation liquor without a heat treatment being performed, and without the enzymes being destroyed. As a result, even small amounts of the liquor will contain large quantities of the enzymes and coenzymes.

The kelp fermentation liquor is obtained by adding sugar to kelp; admixing the sugar with the kelp; changing the osmotic pressure; adding yeast to an essence in the kelp cells that has been extracted from the cells; carrying out fermentation; and separating off the liquid content using a press. The resulting kelp fermentation liquor will contain large quantities of minerals, vitamins, iodine, and other active ingredients originally present in the kelp.

The fermented calcium is water-soluble organic calcium that has a pleasant taste and is absorbed by the body in a highly effective manner. It is obtained by blending a fossilized shell, oyster shell, fish bone, pork bone, or the like with an essence obtained by adding a sugar to a vegetable, a fruit, a sea grass, a cereal, a plant leaf, or the like to cause fermentation to occur. The mixture is then caused to ferment, and then dried and pulverized.

The brown sugar bacteria is a zymogen that has an affinity for brown sugar, and has a characteristic of fermenting ahead of other zymogens.

Accordingly, the decomposed sugar increases the sugar degree in the first fermentation liquor, and serves as a nutrient source for the brown sugar bacteria in the first fermentation liquor. The brown sugar bacteria is the first to start the fermentation process, and thereby acts as a trigger for the natural yeasts originally present on the herb, vegetable, and fruit; lactobacilli, filamentous fungi; actinomycetes; soilborne fungi; and other beneficial organisms to carry out fermentation and multiply. The brown sugar bacteria, yeasts, lactobacilli, and the like that have multiplied cause the herb extract, herb, vegetable fermentation liquor, fruit fermentation liquor, kelp fermentation liquor, fermented calcium, and the like to ferment; and the enzymes, coenzymes, amino acids, organic acids, minerals, and other active ingredients will be extracted.

A papaya fermentation liquor is then added to the first fermentation liquor, and fermentation and ripening are performed, whereby a second fermentation liquor is obtained.

The papaya fermentation liquor is obtained by adding a sugar to the papaya; fermenting the extracted essence using a yeast, a lactobacillus, and natural yeast present on the papaya; and then separating off the liquid content and subsequently fermenting it. Papayas contain papain as well as a variety of other enzymes (e.g., catalase, amylase, lipase, protease, and trehalase), amino acids (various essential amino acids), vitamins (vitamin C, vitamin E, and beta-carotene), minerals (various essential minerals), and other phytonutrients (e.g., catechins and flavonoids).

The first fermentation liquor and the papaya fermentation liquor are blended and thoroughly combined in the second fermentation liquor, and the natural yeast adhering to the papaya and other beneficial organisms present in the papaya fermentation liquor carry out fermentation. The natural yeast and other beneficial organisms that have multiplied also cause the herb extract, herb, vegetable fermentation liquor, fruit fermentation liquor, kelp fermentation liquor, fermented calcium, and the like to ferment; and the active ingredients will be readily absorbed by the body.

Accordingly, when the papaya fermentation liquor is ingested, an effect will be exhibited in terms of regulating enterobacterial balance; i.e., the balance between “good” bacteria (e.g., lactobacillus) and “bad” bacteria (e.g., Clostridium perfringens) Intestinal peristalsis will be energized, and the active ingredients will be digested and absorbed to a much higher degree.

The herb is then removed from the second fermentation liquor, and filtration is performed to yield a health food containing enzymes.

The health food manufactured as described above is a beverage, and is accordingly delivered into the body merely by being drunk. As a result, the action of the digestive enzymes within the body will be aided, and digestion of foods and absorption of nutrients will be promoted; therefore, e.g., immunity will be increased, the bodily constitution will be improved, and illnesses will be more readily avoided.

As has been described above, the present invention is a method for manufacturing a health food containing enzymes that makes it possible to readily and efficiently ingest enzymes, coenzymes, minerals, vitamins, amino acids, organic acids, and other active ingredients that are needed by the body.

### Example

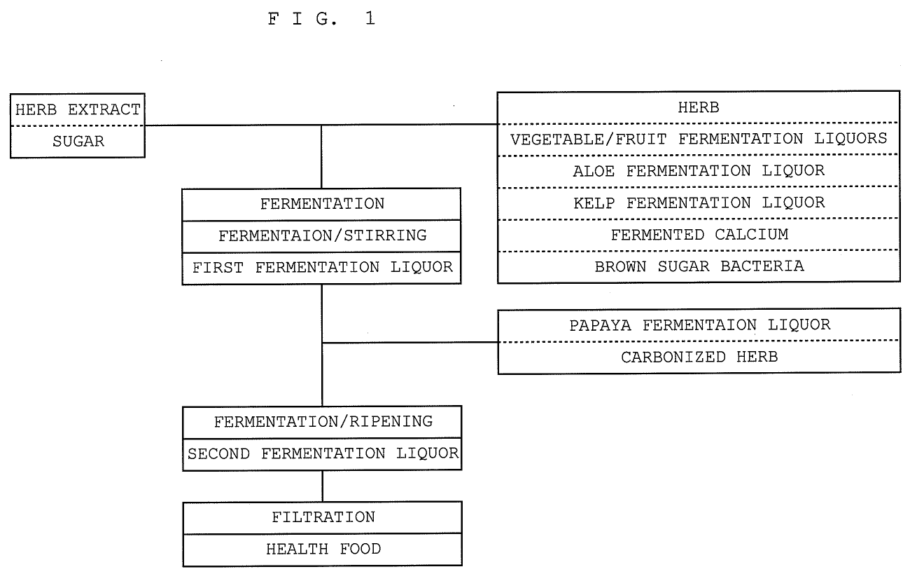

An embodiment of the present invention shall be described with reference to FIG. 1.

The present embodiment is a method for manufacturing a health food containing enzymes, the method comprising three steps; i.e., a step for manufacturing a first fermentation liquor, a step for manufacturing a second fermentation liquor, and a filtration step. Each step is described in detail hereunder.

### 1) Step for Manufacturing First Fermentation Liquor

(1) A sugar, an herb, a vegetable fermentation liquor, a fruit fermentation liquor, a kelp fermentation liquor, fermented calcium, and brown sugar bacteria are added to a herb extract; fermentation is carried out; and a first fermentation liquor is obtained.

Specifically, an herb, a vegetable fermentation liquor and a fruit fermentation liquor manufactured in advance in a separate step, an aloe fermentation liquor manufactured in advance in a separate step, a kelp fermentation liquor manufactured in advance in a separate step, and fermented calcium manufactured in advance in a separate step are introduced into a tank; and blended with a combination obtained by adding a sugar to a herb extract and blending the contents. The herb extract is manufactured in advance in a separate step, and has Artemisia varindica Pampan extract added thereto.

a) Herb Extract to which Artemisia varindica Pampan has Been Added

First, a description of a method for producing the herb extract shall be provided.

A herb is extracted using boiling water, yielding an extract.

Specifically, an herb having a medicinal component is introduced into a crucible. Dried Polygonatum falcatum A. Gray, Gynostemma pentaphyllum, and the like are used as herbs (suitably mixed to a total amount of, e.g., 54.105 kg). The herb is uniformly introduced into two crucibles. The herb has a high mineral content.

Herbs that may be used in addition to Polygonatum falcatum A. Gray and Gynostemma pentaphyllum include Mallotos japonicus (Thunb. ex. L. f.) Müll.-Arg., Chenopodium album L var. centrorubrum Mak., Ginkgo biloba L., Crucuma Longa L., Eleutherococcus sieboldianus (Makino) Koidz., Plantago asiatica L., Hypericum erectum Thunb. ex Murray var. erectum, Cassia mimosoides L. subsp. Nomame (Siebold) H. Ohashi, Clechoma hederacea L. subsp. Grandis (A. Gray) H. Hara, Gynostemma pentahyllum (Thunb.) Makino, Lycium chinense Miller (leaf/fruit), Sasa veitchii (Carr.) Rehd., Cinnamomum cassia Blume, Acanthopanax senticosus (Rupr. et Maxim), Equisetim arvense, Taraxacum officinale, Commeliana communis L. var. communis, Tetragonia tetragonoides (Pall.) Kuntze (T. expansa Murray), Houttuynia cordata Thunberg, Nandinadomestica Thunb., Lonicera japonica Thunberg, Cassia occidenyalis L., Coix lacryma-jobi L., Cassia obtusifolia Linne, Galeola septentrionalis Reichb. f., Maitake/hoshi-maitake, Actinidia polygama, Dioscorea japonica Thunberg, Shiitake/hoshi-shiitake, Canavalia gladiata (Jacq.) D C., Canavalia gladiata (Jacq.) D C., Canavalia gladiata (Jacq.) D C. (stem/leaf), Allium tuberosum Rottl. (stem), Allium tuberosum Rottl. (seed), and Quercus serrata Thunb. ex. Murray, Artemisia varindica Pampan; however, as long as the plant has a medicinal effect, mushrooms, vegetables, cereals, or the like may be used in addition to herbs.

If the herb is used in a dried form, it will be about one-tenth as bulky as when it is its raw form, which will facilitate handling. Numerous varieties of each of the herbs may be used regardless of the season.

Water is then introduced into the two crucibles (in an amount of, e.g., 300 L per crucible), and heated.

The contents are then heated for 1 hr after the water has boiled (at 100° C.), and decoction is performed.

A screen is then used to separate the liquid from the resulting extract, and the solids (e.g., 200 kg) are separated from the liquid extract (e.g., in a total amount of about 300 to 320 L).

The resulting extract is introduced into a crucible and heated for about 1.5 hr at 100° C. while a fan blows a current of air on the liquid surface (e.g., until the amount of liquid reaches about 215 L), whereupon the concentrated matter is used.

The mineral content of the herb (herb concentrate) is extracted by the decocting process described above. An Artemisia varindica Pampan extract manufactured in a separate step (described above) is then admixed therewith, and an herb extract is obtained.

A method for producing the Artemisia varindica Pampan extract shall now be described.

Artemisia varindica Pampan in the form of a powder (e.g., 4 kg) is introduced into a separate crucible. Water (e.g., 50 L) is introduced into the crucible, and the contents are heated for 10 minutes.

The reason that the Artemisia varindica Pampan extract is manufactured in a separate step is that powdered, and not dried, Artemisia varindica Pampan is used. The active ingredients of powdered Artemisia varindica Pampan are extracted in a short period of time by decoction; however, when powdered Artemisia varindica Pampan is decocted together with other herbs, the components from the other herbs will be less readily extracted into the boiling water since the liquor in which the Artemisia varindica Pampan has been blended will have a high viscosity. Accordingly, if dried Artemisia varindica Pampan is used, it can be processed along with the other herbs, as shall be apparent.

### b) Sugar

Superfine sugar, brown sugar, an oligosaccharide, or the like is used as the sugar.

Specifically, superfine sugar (e.g., 270 kg) exhibits an effect of inhibiting unwanted microorganisms from multiplying, and serves as a nutrient source for zymogens. Brown sugar (e.g., 5 kg) is a nutrient source preferred by brown sugar bacteria, while oligosaccharides (e.g., 5 kg) are a nutrient source preferred by lactobacilli.

### c) Herb

A dried herb having a medicinal component is suitably used.

Specific examples of herbs having a medicinal component include Gynostemma pentahyllum (Thunb.) Makino, Hypericum erectum Thunb. ex Murray var. erectum, Cassia mimosoides L. subsp. Nomame (Siebold) H. Ohashi, Lycium chinense Miller (leaf), Sasa veitchii (Carr.) Rehd., Tetragonia tetragonoides (Pall.) Kuntze (T. expansa Murray), pine needles, and Allium sativum L. (suitably mixed to yield, e.g., a total amount of about 2.3 kg); however, these examples shall not be provided by way of limitation as long as the herb contains a natural yeast or another beneficial organism.

Gynostemma pentahyllum (Thunb.) Makino has the effect of improving metabolism, promoting endocrine secretion, and providing a tranquilizing property; and further has the effect of promoting adrenocortical hormone secretion.

Hypericum erectum Thunb. ex Murray var. erectum has the effect of increasing the brain chemicals dopamine, serotonin, and norepinephrine. It is effective against depression and insomnia. Cassia mimosoides L. subsp. Nomame (Siebold) H. Ohashi has tonifying, diuretic, and antitussive effects as well as being effective against beriberi, nephritis, jaundice, migraine, chronic constipation, and night blindness.

Lycium chinense Miller (leaf) has the effect of maintaining normal liver function, and regulating blood pressure. It has a preventive effect against heart disease, kidney disease, and arteriosclerosis; and is effective against intolerance to cold, constipation, and fever.

Sasa veitchii (Carr.) Rehd. has an antioxidative effect, and contains large amounts of bamfolin and chlorophyll for boosting immunity, yielding an effect whereby the constitution is more resistant to cancer and lifestyle-related diseases.

Tetragonia tetragonoides (Pall.) Kuntze (T. expansa Murray) contains vitamins, minerals, and chlorophyll; and the mucilage contained in the leaves has the effect of protecting the mucous membranes.

Pine needles contain vitamins, terpenes, polysaccharide complexes, minerals, catechins, and chlorophyll; and have the effect of softening the blood vessels and increasing the neurotransmitter strength.

Allium sativum L. contains scordinin and allicin, and has the effect of heightening the function for burning nutrients in the body and converting them to energy, as well as the function of vitamin B1, which is useful for alleviating fatigue. Allium sativum L. also has the effect of improving gastrointestinal function.

The aforementioned herbs contain large amounts of natural yeast that originally adhere to the herbs as well as other beneficial organisms.

### d) Vegetable Fermentation Liquor and Fruit Fermentation Liquor

In the present embodiment, the vegetable fermentation liquor and fruit fermentation liquor are not manufactured separately; the vegetables and the fruit are blended together, and the vegetable fermentation liquor and fruit fermentation liquor are manufactured simultaneously. In the present embodiment, an aloe fermentation liquor (described hereunder) is manufactured using a step that is different from the step used to manufacture the vegetable fermentation liquor and fruit fermentation liquor, but may be manufactured in the same step. The vegetable fermentation liquor and fruit fermentation liquor are obtained by washing and then comminuting raw vegetables and fruit; adding sugar and blending the contents; adding yeast and brown sugar bacteria to promote fermentation over about 10 to 14 days while stirring the mixture once a day; causing the yeast, the brown sugar bacteria, and the natural yeasts originally present on the vegetables and fruit and other beneficial organisms to multiply; and separating off the liquid content using a press.

More specifically, bean sprouts, cucumber, spinach, pineapples, apples, lemons, and other vegetables and fruits in their raw form are used (suitably mixed to reach a total amount of, e.g., about 90 kg); however, these shall not be provided by way of limitation as long as the vegetables and fruit contain enzymes.

The vegetables and fruit are washed, finely diced or sliced, and introduced into a container. Superfine sugar is introduced as the sugar (e.g., 90 kg), the osmotic pressure is changed, and the essence within the cells of the vegetables and fruit is extracted therefrom.

The essence contains a diversity of enzymes, amino acids, vitamins, minerals, and other plant nutrients (e.g., carotene). The main ingredients of in each of the essences are given below.
Bean sprouts: amylase, vitamin C, asparagene
Cucumber: ascorbinase, vitamins, minerals, isoquercitrin
Spinach: nitrate reductase, carotene, vitamins, minerals
Cabbage: peroxidase, cabbage chitinase, diastase, vitamins, vitamin U
Onion: maltase, cholesterol-synthesis-inhibiting enzyme, glucokinin, allyl sulfide, quercetin
Parsley: ascorbic acid peroxidase, minerals, vitamins
Potato: minerals, vitamin C, polyphenol, chlorogenic acid
Ginseng: ascorbinase, carotene, calcium, dietary fiber
Broccoli: myrosinase, sulforaphane, vitamin C, carotene, vitamin B2, potassium, calcium
Great burdock: peroxidase, inulin
East Indian lotus root: catalase, peroxidase, vitamins, dietary fiber, mucin
Japanese mustard spinach: diastase, calcium, vitamins
Turnip: phloroglucinol oxidase, amylase, vitamin C, diastase
Tomato: endopolygalacturonase, ascorbinase, vitamins, potassium, lycopene
Japanese radish: diastase, amylase, vitamins, carotene, calcium
Pineapple: bromelain, carbohydrates, vitamins
Apple: Malate dehydrogenase, malic acid, citric acid, pectin
Lemon: vitamin C, citric acid

If superfine sugar is used as the sugar (e.g., 90 kg), an effect is obtained whereby unwanted microorganisms are inhibited from multiplying, and the sugar serves as a nutrient source when the zymogen causes fermentation.

Vineyard yeast or another yeast (e.g., 200 mL) and brown sugar bacteria (e.g., 2 L) are then introduced, and natural yeast originally present on the vegetable and fruit or another beneficial organism are caused to produce fermentation and multiply for about 10 to 14 days.

During this process, stirring is performed manually for about 30 min per day so as not to damage the yeast or brown sugar bacteria; therefore, fermentation is carried out in a satisfactory manner. The fermentation causes the vineyard yeast and other yeasts, the brown sugar bacteria, and natural yeasts and other beneficial organisms to multiply.

A press is then used to separate the residue from the vegetable fermentation liquor and fruit fermentation liquor (e.g., a total amount of about 125 L).

The resulting vegetable fermentation liquor and fruit fermentation liquor will have undergone fermentation without the use of heat; therefore, even small amounts thereof will have particularly large quantities of enzymes.

Specifically, as has been described above, enzymes contained in raw fruits and vegetables will inevitably be destroyed by heating; however, according to the present embodiment, a method is adopted wherein the enzymes are not subjected to a heat treatment, but are extracted as a fermentation liquor without being destroyed. As a result, even small quantities of the vegetable fermentation liquor and fruit fermentation liquor will contain large quantities of enzymes.

### e) Aloe Fermentation Liquor

An aloe fermentation liquor is obtained by washing and then comminuting aloe, adding a sugar and yeast thereto, carrying out fermentation for about 10 to 14 days while stirring the combination once a day, causing the yeast as well as natural yeast originally present on the aloe and other beneficial organisms to multiply, and subsequently separating off the liquid content using a press.

Specifically, raw aloe (e.g., in a total amount of about 90 kg) is washed, diced or sliced, and introduced into a container.

Superfine sugar (e.g., 90 kg) is introduced as the sugar, the osmotic pressure is changed, and the essence within the aloe cells is extracted therefrom. Using superfine sugar (e.g., 90 kg) enables the sugar to serve as a nutrient when fermentation is carried out, and has the effect of suppressing multiplying of unwanted microorganisms because the sugar is refined.

Vineyard yeast or another yeast (e.g., 100 mL) is then introduced, and fermentation is carried out for about 10 to 14 days, whereupon the yeast, natural yeast originally present on the aloe, and other beneficial organisms multiply. During this process, stirring is performed manually once a day for about 30 min so as not to damage the yeast.

A press is used to separate off the liquid content, whereby an aloe fermentation liquor is obtained (e.g., in a total amount of about 130 L).

The aloe fermentation liquor contains oxidases (oxidation enzymes), catalases (hydrogen peroxide-scavenging enzymes), amylases (starch-decomposing enzymes), lipases (lipid-decomposing enzymes), and other digestive enzymes; essential amino acids, aloin, aloe-emodin, aloeursin, and other components. Since fermentation is carried out without heating, even small amounts of the aloe fermentation liquor will contain particularly large quantities of enzymes. Specifically, as described above, the enzymes contained in raw fruits and vegetables will inevitably be destroyed by heating; however, according to the present embodiment, a method is adopted wherein the enzymes are not subjected to a heat treatment, but are extracted as a fermentation liquor without being destroyed. As a result, even small quantities of the aloe fermentation liquor will contain large quantities of enzymes.

### f) Kelp Fermentation Liquor

A kelp fermentation liquor is obtained by washing and then comminuting kelp; adding a sugar and yeast thereto; carrying out fermentation for about 10 to 14 days while stirring the combination once a day; causing the yeast, natural yeast originally present on the kelp, and other beneficial organisms to multiply; and subsequently separating off the liquid content using a press.

Specifically, the kelp (e.g., 1 kg) is washed, sliced, and introduced into a container.

Superfine sugar (e.g., 1 kg) is introduced as the sugar, water (3 L) is also introduced, the osmotic pressure is changed, and the essence within the kelp cells is extracted.

A yeast is then introduced; fermentation is carried out for about 10 to 14 day; and the yeast, natural yeast originally present on the kelp, and other beneficial organisms are allowed to multiply. During this process, stirring is performed manually once a day for about 30 min so as not to damage the yeast.

A press is used to separate off the liquid content, whereby a kelp essence (e.g., 4 L) is obtained.

The kelp essence is further fermented for about 2 to 3 weeks at a sugar degree of about 47 to 48° and a pH of about 2.5 to 3.5; and the yeast as well as natural yeast and other beneficial organisms are allowed to multiply.

The minerals, vitamins, iodine, and dietary fiber originally contained in the kelp will be present in an abundance and in a good balance in the kelp fermentation liquor.

### g) Fermented Calcium

The fermented calcium is water-soluble organic calcium (pertaining to art taught in JP 3308475), which is manufactured in three steps. In the first step, a sugar is added to a vegetable, a fruit, a sea grass, a cereal, a plant leaf, or the like to cause fermentation at a sugar degree of 50 to 55°; the fermented material is filtered; and a moromi extract is prepared. In the second step, a fossilized shell, oyster shell, fish bone, or pork bone is blended with the moromi extract produced in the first step; a reaction is brought about between the moromi extract and the inorganic calcium contained in the fossilized shell, oyster shell, fish bone, or pork bone; fermentation is carried out; and the inorganic calcium is changed to organic calcium. In the third step, the reaction-fermented material is dried and pulverized to yield a powder.

Specifically, 100 g of the fermented calcium is used.

The fermented calcium has a pleasant taste and is absorbed by the body in an extremely effective manner.

### h) Brown Sugar Bacteria

The brown sugar bacteria is a zymogen that has an affinity for brown sugar, and has a characteristic of fermenting ahead of other zymogens.

### (2) Step for Blending (a) Through (g)

First, the brown sugar (e.g., 5 kg) and oligosaccharide (e.g., 5 kg) described in (b) are added to and blended with the Artemisia varindica Pampan extract described in (a). The superfine sugar (e.g., 270 kg) described in (b) is added to and blended with the herb concentrate described in (a).

The Artemisia varindica Pampan extract and the herb concentrate are introduced into a tank. The temperature of the Artemisia varindica Pampan extract and the herb concentrate is set to 48° C. or less during this process, and this restriction is imposed so that the enzymes introduced from each of the liquors in the steps as stated below will not be destroyed.

The Artemisia varindica Pampan extract and the herb concentrate may be blended in advance, and then introduced into the tank.

The dried herb described in (c), the vegetable fermentation liquor and fruit fermentation liquor described in (d), the aloe fermentation liquor described in (e), the kelp fermentation liquor described in (f), and the fermented calcium described in (g) are then introduced into the tank and blended therein. The brown sugar bacteria described in (h) is then added, whereupon the contents are manually stirred and left to stand for 10 to 14 days at a room temperature of 20 to 27° C. and a humidity of 40 to 60%. The mixture is then left to stand for about 1.5 months. During this time, the mixture is stirred about 5 mins once each day, fermentation is promoted, and a first fermentation liquor is obtained.

In the first fermentation liquor, the sugar described in (b) will have been introduced into a heated Artemisia varindica Pampan extract and a heated herb concentrate, and thus will be thoroughly dissolved.

### 2) Step for Manufacturing a Second Fermentation Liquor

(1) A papaya fermentation liquor is added to the first fermentation liquor; fermentation and ripening and carried out; and a second fermentation liquor is obtained.

Specifically, a carbonized herb that has been prepared in advance in a separate step is blended with a papaya fermentation liquor that has been prepared in advance in a separate step, and fermentation is carried out for 30 days. The papaya fermentation liquor containing the carbonized herb is introduced into the first fermentation liquor, fermentation and ripening are carried out for 5 to 6 months, and a second fermentation liquor is obtained.

### a) Papaya Fermentation Liquor Containing Carbonized Herb

The papaya fermentation liquor containing a carbonized herb is obtained by adding a pulverized carbonized herb to the papaya fermentation liquor, blending the contents, and carrying out fermentation and ripening for 30 days.

### i) Papaya Fermentation Liquor

The papaya fermentation liquor is obtained by comminuting a papaya; adding a sugar; extracting the essence within the papaya cells using osmotic pressure; adding a vineyard yeast or another yeast and lactobacillus to the resulting essence; stirring the combination at least once a day to promote fermentation over about 10 to 14 days; allowing the yeast, lactobacillus, and natural yeast originally present on the papaya to multiply; separating off the liquid content using a press; and subjecting the resulting liquid to further fermentation and ripening for 30 days.

Specifically, the papaya fermentation liquor is manufactured using the following step.

Japanese papaya is used as the starting material. Papayas imported into Japan contain high quantities of preservatives and insecticides, which are undesirable for manufacturing health foods.

The papaya is also pesticide-free.

The papaya (80 kg) is washed, sliced or diced, and introduced into a tank, whereupon superfine sugar (80 kg) is introduced, the osmotic pressure is changed, and the essence within the papaya cells is extracted.

The essence contains papain as well as a variety of other enzymes (e.g., catalase, amylase, lipase, protease, and trehalase), amino acids (various essential amino acids), vitamins (e.g., vitamin C, vitamin E, and beta-carotene), minerals (various essential minerals), and other phytonutrients (e.g., catechins and flavonoids).

It is possible to add small amounts of both the comminuted papaya and sugar in an alternating manner so as to apply osmotic pressure as evenly as possible to the papaya cells.

If superfine sugar is used as the sugar, an effect is obtained whereby unwanted microorganisms are inhibited from multiplying, and the sugar serves as a nutrient source when zymogens cause fermentation.

The yeast (e.g., 200 mL) and lactobacillus are then introduced; fermentation is carried out for 10 to 14 days with the contents being manually stirred once a day; and the yeast, the lactobacillus, and natural yeast originally present on the papaya are caused to multiply. The yeast, lactobacillus, and natural yeast originally present on the papaya interact well with one another as a result of fermentation and multiplying.

The period during which symbiotic culturing is performed will differ depending on the equipment used and other factors, but is regarded as the time over which about 70% of the essence in the papaya cells is extracted therefrom.

In the present embodiment, the term “yeast” denotes vineyard yeast, alcohol yeast, beer yeast, and other generic species of yeast.

Once the residue has been separated from the papaya liquor using the press, the papaya liquor is transferred into a fermentation tank. At an appropriate point in time, vineyard yeast or another yeast is added thereto and blended therewith, and fermentation is carried out for 30 days. During this time, the contents are stirred for 15 min once a day using a rod while skimming.

The papaya fermentation liquor will contain a liquid component exhibiting a powerful SOD (superoxide dismutase) action, which has the effect of regulating enterobacterial balance.

Specific examples of effects demonstrated by the papaya fermentation liquor include cleansing of the blood; activating cells; improving blood circulation; preventing arteriosclerosis; improving digestion, absorption, and metabolism (e.g., improving nutrient cycling); inhibiting pathogens and harmful bacteria from multiplying as well as minimizing the incidence of associated infection; invigorating the immune system; increasing the production of hormones and vitamins; promoting the decomposition and excretion of carcinogens and other harmful substances; stabilizing intestinal pH; stimulating bowel activity; improving metabolism of lipids and sugars; and activating and maintaining hepatorenal function.

### ii) Carbonized Herb

A carbonized herb is obtained by using far-infrared irradiation to subject an herb to carbonization (pertains to the art taught in JP patent application No. 2005-84105).

The herb produced by the above method shall not be provided by way of limitation as long as the herb is carbonized.

Specifically, when the dried herb is to be heated in a kiln, far-infrared irradiation is directed on the herb to carbonize it, whereupon the carbonized herb is pulverized into a finer form.

The herb may be suitably selected from among Chenopodium album L var. centrorubrum Mak., Mallotus japonicus (Thunb. ex Murray) Müll.-Arg., Gynostemma pentahyllum (Thunb.) Makino, Ginkgo biloba L., Eleutherococcus sieboldianus (Makino) Koidz., Crucuma Longa L., Acanthopanax senticosus (Rupr. et Maxim), Plantago asiatica L., Hypericum erectum Thunb. ex Murray var. erectum, Clechoma hederacea L. subsp. Grandis (A. Gray) H. Hara, Cassia mimosoides L. subsp. Nomame (Siebold) H. Ohashi, Giycyrrhiza uralensis Fisher, Aloe arborescens, Lycium chinense Miller (leaf/fruit), Sasa veitchii (Carr.) Rehd., Cinnamomum cassia Blume, Cassia obtusifolia, Equisetim arvense, Taraxacum officinale, Galeola septentrionalis Reichb. f., Commeliana communis L. var. communis, Tetragonia tetragonoides (Pall.) Kuntze (T. expansa Murray), Houttuynia cordata Thunberg, Polygonatum falcatum A. Gray, Nandinadomestica Thunb., Lonicera japonica Thunberg, Coix lacryma-jobi L., Cassia occidenyalis L., Actinidia polygama, Dioscorea japonica Thunberg, Artemisia varindica Pampan; Canavalia gladiata (Jacq.) D C., Maitake/Hoshi-Maitake, Shiitake/Hoshi-Shiitake, Agaricus subrufescens, and Phellinus Linteus; however, as long as the plant has a medicinal effect, mushrooms, vegetables, cereals, or the like may be used in addition to herbs.

It is also possible to use, e.g., the residue left after the herb has been decocted in the first fermentation liquor (active ingredients that could not be completely extracted are contained in this residue). The residue of herbs that had previously been disposed of can be advantageously used in such instances.

iii) Step for Fermenting and Ripening (i) and (ii)

The carbonized herb (e.g., 0.16 kg) described in (ii) is added to and blended with the papaya fermentation liquor (e.g., 20 L) described in (i), and the mixture is left to stand for about 30 days. The mixture ferments and ripens by being left to stand for about 30 days, resulting in a papaya fermentation liquor containing a carbonized herb.

The papaya fermentation liquor and the carbonized herb will interact well with each other as a result of the process of fermentation and ripening lasting about 30 days.

The admixed carbonized herb will ferment and decompose into a smaller form, providing the variety of effects associated with the herb along with an effect derived from the adsorptive property obtained from the small adsorption holes that are characteristic of carbonized herbs, while also reducing instances of constipation and imparting an excellent texture.

### b) Fermentation/Ripening Step

The papaya fermentation liquor containing a carbonized herb described in (a) is added to and blended with the first fermentation liquor, and fermentation and ripening are carried out for 5 to 6 months, resulting in a second fermentation liquor.

The 5 to 6 months of fermentation and ripening causes the beneficial bacteria to multiply to a moderate level, so that the second fermentation liquor will not only contain large quantities of a variety of enzymes, coenzymes, vitamins, organic acids, minerals, and other active ingredients, but will contain the enzyme SOD, which has the effect of eliminating active oxygen, and other active ingredients. The fermented material will accordingly tend not to perish, while remaining stable.

### 3) Filtration Step

The herbs are removed from the second fermentation liquor, and filtration is performed, whereupon the filtrate is separated and extracted. The filtrate is then bottled or otherwise processed, resulting in a health food containing enzymes.

The resulting health food has a pH of approximately 3.7 to 3.9, an alcohol degree of approximately 2.5 to 4.0%, and a final sugar degree of approximately 45 to 53°, and preferably 52 to 53°.

Subjects were asked to ingest the health food containing enzymes as obtained in the present embodiment, and the results are described below.

(1) A female subject experienced a tingling sensation and stiffness in her fingertips that kept her awake during the night; however, the symptoms improved once she had ingested the health food, whereupon she was able to sleep soundly.

(2) A male subject said that his fingernails grew stiffer and looked pink as part of an overall improvement in his nail condition, while also experiencing an improvement in his constitution over time.

(3) A male subject experienced a stabilization in blood pressure as well as improved stool passage.

(4) A female subject who ingested the health food regularly over approximately one year found that a polyp on her gall bladder had disappeared.

(5) A male subject saw a decrease in his cholesterol level.

(6) A male subject felt refreshed and less sluggish after having started to ingest the health food.

(7) A female subject was able to cope well through the summer without feeling lethargic.

(8) A female subject thought that the food was very pleasant to ingest.

What is claimed is:

1. A method for manufacturing a health food containing enzymes, wherein:
a first fermentation liquor is obtained by decocting an herb to yield an extract; adding a sugar, an herb, a vegetable fermentation liquor, a fruit fermentation liquor, a kelp fermentation liquor, fermented calcium, and brown sugar bacteria to the herb extract at a temperature where enzyme activity can be maintained; and carrying out fermentation;
a second fermentation liquor is subsequently obtained by adding a papaya fermentation liquor to the first fermentation liquor, and carrying out fermentation and ripening; and
the second fermentation liquor is subsequently filtered.

2. The method of claim 1, wherein:
the herb extract has Artemisia varindica Pampan admixed therewith;
the vegetable fermentation liquor is obtained by adding a sugar to a vegetable, adding a yeast to an extracted essence, and carrying out fermentation;
the fruit fermentation liquor is obtained by adding a sugar to a fruit, adding a yeast to an extracted essence, and carrying out fermentation;
the kelp fermentation liquor is obtained by adding a sugar to kelp, adding a yeast to an extracted essence, and carrying out fermentation;
the fermented calcium is obtained by blending an essence with a fossilized shell, an oyster shell, a fish bone, a pork bone, or the like; and carrying out fermentation, drying, and subsequent pulverization, the essence being obtained by adding a sugar to a vegetable, a fruit, a sea grass, a cereal, a plant leaf, or the like; and carrying out fermentation; and
the papaya fermentation liquor is obtained by adding a sugar to a papaya, adding a yeast and a lactobacillus to an extracted essence, and carrying out fermentation.

3. The method of claim 2, wherein the papaya fermentation liquor has charcoal added thereto.

4. The method of claim 3, wherein the charcoal is a carbonized herb.

5. The method of claim 1, wherein the first fermentation liquor includes an aloe fermentation liquor.

6. A health food manufactured using the method of claim 1, wherein the sugar degree of the health food is 45° or higher.

7. A health food manufactured using the method of claim 2, wherein the sugar degree of the health food is 45° or higher.

8. A health food manufactured using the method of claim 3, wherein the sugar degree of the health food is 45° or higher.

9. A health food manufactured using the method of claim 4, wherein the sugar degree of the health food is 45° or higher.

10. A health food manufactured using the method of claim 5, wherein the sugar degree of the health food is 45° or higher.
